(19) United States
(12) Patent Application Publication
(10) Pub. No.: US 2006/0136847 A1
(43) Pub. Date: Jun. 22, 2006

(54) Method and computer program product for verifying a computer renderable document for on-screen appearance

(75) Inventors: Roger B. Agellon, Surrey (CA); Kyle Nathan Patrick, British Columbia (CA)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/238,910

(22) Filed: Sep. 29, 2005

(30) Foreign Application Priority Data
Dec. 16, 2004 (CA) 2,490,300

(51) Int. Cl. G06K 9/32

(52) U.S. Cl. 715/866; 345/698; 382/299

(57) ABSTRACT

A method and computer program product for verifying on-screen appearance of a document. A selected window is provided to an application. An image of the document is rendered at the selected window resolution on a screen of a reference display monitor of a reference computing platform on which the application is executed to perform the rendering. The rendered image emulates a rendered on-screen appearance of the image at the selected window resolution on a screen of another display monitor of another computing platform. The screen of the another display monitor has a smaller window size than the screen of the reference display monitor. The reference display monitor's maximum window resolution exceeds the selected window resolution. It is determined whether the emulated image meets acceptance criteria. For other window resolutions, the method repeats: providing an input signal, rendering the image of the document, and determining if the acceptance criteria are satisfied.

### BACKGROUND OF THE INVENTION

1. Technical Field

The present invention relates generally to the field of computer rendering of visual content and, in particular, to a method and a computer program product for verifying a computer renderable document for on-screen appearance.

2. Related Art

A computer renderable descriptive mark-up language defined document may look acceptable at one screen resolution but may be unacceptable at another screen resolution. Screen resolution herein refers to the dimensions (vertical and horizontal) of the screen presentation usually specified in pixels. A display device may support a collection of screen resolution settings. The computer renderable document may contain visual elements that use a combination of device dependent and device independent positioning algorithms during rendering.

The designer of the document would like to be able to verify the appearance of a computer renderable descriptive mark-up language defined document at a variety of different screen resolutions. This is done by manually changing the screen resolution of the display device (e.g. computer monitor) and maximizing the display window associated with an application used to render the document (e.g. a browser application). These steps must be repeated for each screen resolution setting that the document designer wishes to verify.

The preceding described approach to verifying a computer renderable descriptive mark-up language defined document for on-screen appearance at different screen resolutions can be labor intensive.

Thus there is a need for a method and computer program product for verifying a computer renderable document for on-screen appearance which mitigates shortcoming of approaches of the related art such as the above described approach.

### SUMMARY OF THE INVENTION

The present invention provides a method for verifying a computer renderable document for on-screen appearance when displayed by an application adapted to apply any one of a plurality of predetermined window resolutions responsive to an input signal, said method comprising the steps of:

identifying the computer renderable document to be verified for the application;

providing an input signal to the application to select a window resolution of the plurality of predetermined window resolutions;

rendering an image of the document at the selected window resolution on a screen of a reference display monitor of a reference computing platform, wherein the rendered image at the selected window resolution on the screen of the reference display monitor emulates a rendered on-screen appearance of the image at the selected window resolution on a screen of another display monitor of another computing platform, wherein the screen of the another display monitor has a smaller window size than does the screen of the reference display monitor, wherein the reference display monitor comprises a maximum window resolution greater than the selected window resolution, and wherein said rendering is performed by executing the application on the reference computing platform;

determining if the emulated on-screen appearance of the image of the screen of the another display monitor of the another computing platform meets predetermined acceptance criteria at the selected window resolution; and

repeating, for each of the other window resolutions of the plurality of predetermined window resolutions, the steps of providing an input signal, rendering an image of the document, and determining if the on-screen appearance of the computer renderable document meets the predetermined acceptance criteria.

The present invention provides a computer program product for verifying a computer renderable document for on-screen appearance when displayed by an application adapted to apply any one of a plurality of predetermined window resolutions responsive to an input signal, said computer program product comprising computer executable instructions for performing a method, said method comprising the steps of:

identifying the computer renderable document to be verified for the application;

providing an input signal to the application to select a window resolution of the plurality of predetermined window resolutions;

rendering an image of the document at the selected window resolution on a screen of a reference display monitor of a reference computing platform, wherein the rendered image at the selected window resolution on the screen of the reference display monitor emulates a rendered on-screen appearance of the image at the selected window resolution on a screen of another display monitor of another computing platform, wherein the screen of the another display monitor has a smaller window size than does the screen of the reference display monitor, wherein the reference display monitor comprises a maximum window resolution greater than the selected window resolution, and wherein said rendering is performed by executing the application on the reference computing platform;

determining if the emulated on-screen appearance of the image of the screen of the another display monitor of the another computing platform meets predetermined acceptance criteria at the selected window resolution; and

repeating, for each of the other window resolutions of the plurality of predetermined window resolutions, the steps of providing an input signal, rendering an image of the document, and determining if the on-screen appearance of the computer renderable document meets the predetermined acceptance criteria.

The present invention provides a method and computer program product for verifying a computer renderable document for on-screen appearance which mitigates shortcoming of approaches in the related art.

Other aspects and features of embodiments of the present invention will become apparent to those ordinarily skilled in the art to which it pertains upon review of the following description of specific embodiments of the invention in conjunction with the accompanying Figures.

### BRIEF DESCRIPTION OF THE DRAWINGS

FIG. 1 is a schematic representation of an exemplary means of providing an input signal to the application indicating one of plurality of predetermined window resolutions using a menu selection.

FIG. 2 is a schematic representation of an exemplary means of providing an input signal to the application indicating one of plurality of predetermined window resolutions using a command line parameter.

FIG. 3 is a schematic representation of an exemplary means of providing an input signal to the application indicating one of plurality of predetermined window resolutions using an inter-process procedure call.

FIG. 4 is flow diagram representing the steps in a method for verifying a computer renderable document for on-screen appearance when displayed by an application adapted to applying any one of a plurality of predetermined window resolutions responsive to an input signal.

### DETAILED DESCRIPTION OF THE INVENTION

Aspects of embodiments of the present invention provide a method and a computer program product for verifying a computer renderable document for on-screen appearance when displayed by an application (e.g. a browser application) adapted to applying any one of a plurality of predetermined window resolutions responsive to an input signal. The computer renderable document (e.g. a HTML page) can be identified to the application (e.g. a browser application) via, for example, a universal resource locator (URL). An input signal is provided to the application indicating one of plurality of predetermined window resolutions. The predetermined window resolutions may correspond to, for example, a set of standard computer monitor sizes (e.g. 1024×768 pixels). Predetermined acceptance criteria can be used to determine if the on-screen appearance of the computer renderable document, at the input window resolution, is acceptable. The steps of inputting a signal and accessing the acceptability of the on-screen appearance can be repeated for other window resolutions to be verified.

In accordance with one aspect of an embodiment of the present invention, there is provided a method for verifying a computer renderable document for on-screen appearance when displayed by an application adapted to applying any one of a plurality of predetermined window resolutions responsive to an input signal, the method comprising the steps of: identifying the computer renderable document to be verified for the application; providing an input signal to the application indicating one of the plurality of predetermined window resolutions; determining if the on-screen appearance of the computer renderable document meets predetermined acceptance criteria; and repeating, for other window resolutions to be verified, the steps of providing an input signal and determining if acceptance criteria are met.

In accordance with an aspect of another embodiment of the present invention, a computer program product is provided for verifying a computer renderable document for on-screen appearance when displayed by an application adapted to applying any one of a plurality of predetermined window resolutions responsive to an input signal, the computer program product comprising: computer executable instructions for: identifying the computer renderable document to be verified to the application; providing an input signal to the application indicating one of the plurality of predetermined window resolutions; determining if the on-screen appearance of the computer renderable document meets predetermined acceptance criteria; and repeating, for other window resolutions to be verified, the steps of providing an input signal and determining if acceptance criteria are met.

The embodiments of the present invention are directed to a method and a computer program product for verifying a computer renderable document for on-screen appearance when displayed by an application adapted to applying any one of a plurality of predetermined window resolutions responsive to an input signal. The application can be, for example, a web browser or similar application that provides for the rendering of visual elements in the document on to a viewing screen such as, for example, a computer monitor.

The computer renderable document is one that contains renderable visual elements defined in any or a combination of description mark-up languages such as, for example, HTML, XML and other similar descriptive mark-up languages. The rendered contents of the document are often referred to as a page in the context of the application. The computer renderable document is identified to the application via a well known location mechanism such as, for example, a universal resource locator (URL), a file system pathname/filename or other similar document location mechanism.

The computer renderable document may contain visual elements that use positioning algorithms for rendering the document, wherein the positioning algorithms may be device dependent, device independent, or both device dependent and device independent.

An input signal is provided to the application indicating one of plurality of predetermined window resolutions to be applied. The predetermined window resolutions corresponding to, for example, a set of standard computer monitor sizes such as, for example, 640×480, 800×600, 1024×768, 1280×1024 and 1600×1200 pixels. A reference computing platform on which the application executes preferably includes a reference display monitor having a maximum window resolution equal to or greater than the largest window resolution indicated by the input signal. The predetermined window resolutions allow the application to be used to emulate the rendered on-screen appearance for other computing platforms having smaller display monitors of screen sizes corresponding to the predetermined window resolutions.

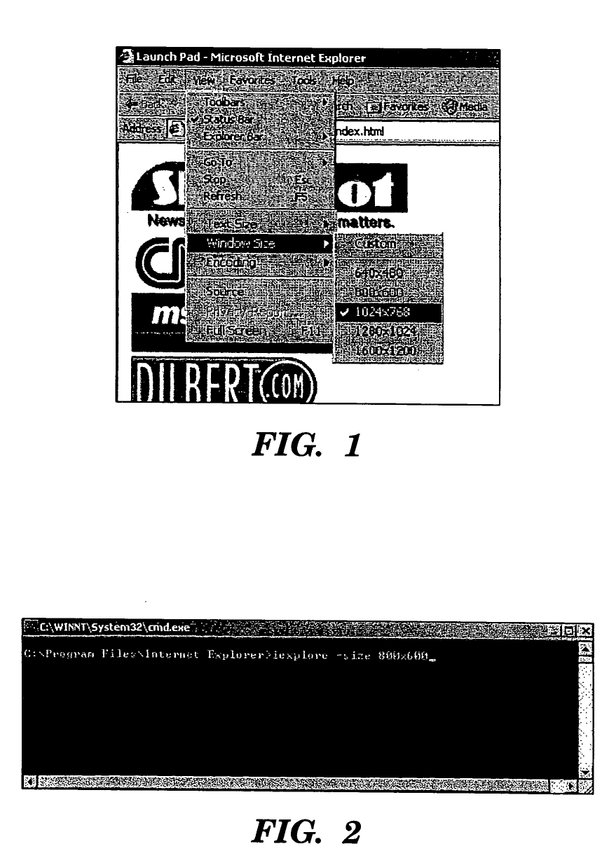

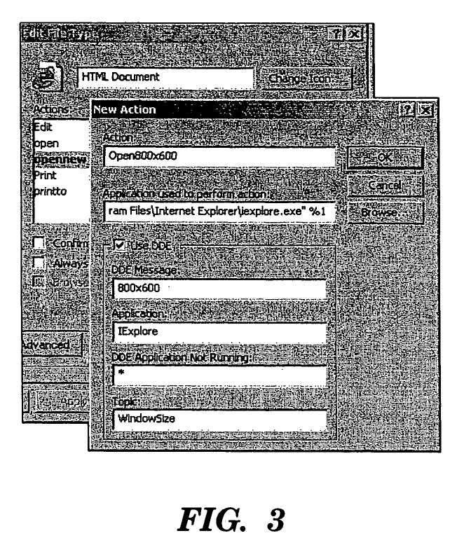

The input signal to the application can take the form of a menu selection, a command key sequence (a.k.a. hot-key combination), a command line parameter, a inter-process procedure call and other similar signal input mechanisms. FIG. 1 is a schematic representation of an exemplary means of providing an input signal to the application indicating one of plurality of predetermined window resolutions using a menu selection. FIG. 2 is a schematic representation of an exemplary means of providing an input signal to the application indicating one of plurality of predetermined window resolutions using a command line parameter. FIG. 3 is a schematic representation of an exemplary means of providing an input signal to the application indicating one of plurality of predetermined window resolutions using an inter-process procedure call. The inter-process procedure call mechanism can be one of dynamic data exchange (DDE), component object model (COM), remote procedure call (RPC) and other similar inter-process procedure call mechanisms.

Predetermined acceptance criteria are used to determine if the on-screen appearance of the computer renderable document, at the input window resolution, is acceptable. Acceptability of the on-screen appearance can be directed to aspects of comprehensibility, aesthetics and combinations thereof. The determination of acceptability can be made by a human operator where the outcome is one of acceptable and unacceptable.

The steps of inputting a signal and accessing the acceptability of the on-screen appearance are repeated for other window resolutions to be verified. This approach can be use to quickly and efficiently verify the on-screen appearance of a computer renderable document by an application for a plurality of window resolutions representing standard screen sizes.

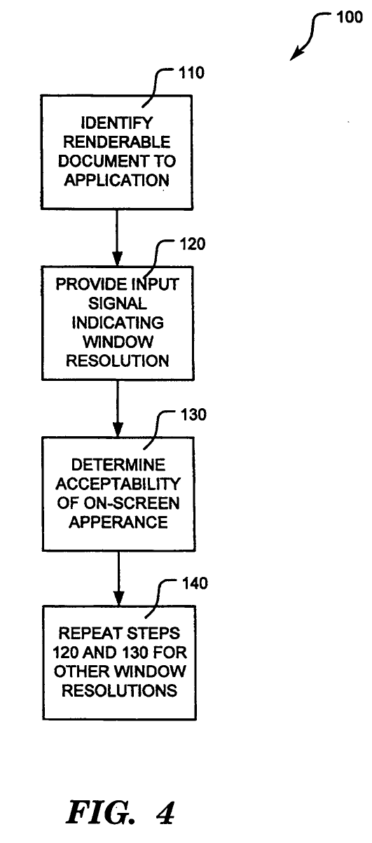

FIG. 4 is flow diagram representing the steps in a method 100 for verifying a computer renderable document for on-screen appearance when displayed by an application adapted to applying any one of a plurality of predetermined window resolutions responsive to an input signal according to the present invention. In step 110 the computer renderable document is identified to the application. This permits the application to render and display the visual element contents of the document in the form of a display page. In step 120, an input signal is provided to the application indicating one of the plurality of predetermined window resolutions. The different window resolutions are used to emulate the rendering of on-screen appearance for computing platforms having display monitors of sizes corresponding to the predetermined window resolutions. In step 130, the acceptability of the on-screen appearance of the computer renderable document, for the window resolution input in step 120, can be determined using predetermined acceptance criteria. A human operator can make the determination of acceptable or unacceptable based on aspects of comprehensibility, aesthetics and combinations thereof. In step 140, the steps of inputting a signal 120 and determining the acceptability of the on-screen appearance 130, can be repeated for other window resolutions in the plurality of predetermined window resolutions until all window resolutions of interest are verified.

The embodiment of a method according to the present invention can be implemented by a computer program product comprising computer executable instructions adapted to execute the steps of the method as described above. Such a computer program product can be executed on any of a number of general purpose and purpose-built computing platforms. It will be apparent to one skilled in the art that numerous modifications and departures from the specific embodiments described herein may be made without departing from the spirit and scope of the present invention.

What is claimed is:

1. A method for verifying a computer renderable document for on-screen appearance when displayed by an application adapted to apply any one of a plurality of predetermined window resolutions responsive to an input signal, said method comprising the steps of:
identifying the computer renderable document to be verified for the application;
providing an input signal to the application to select a window resolution of the plurality of predetermined window resolutions;
rendering an image of the document at the selected window resolution on a screen of a reference display monitor of a reference computing platform, wherein the rendered image at the selected window resolution on the screen of the reference display monitor emulates a rendered on-screen appearance of the image at the selected window resolution on a screen of another display monitor of another computing platform, wherein the screen of the another display monitor has a smaller window size than does the screen of the reference display monitor, wherein the reference display monitor comprises a maximum window resolution greater than the selected window resolution, and wherein said rendering is performed by executing the application on the reference computing platform;
determining if the emulated on-screen appearance of the image of the screen of the another display monitor of the another computing platform meets predetermined acceptance criteria at the selected window resolution; and
repeating, for each of the other window resolutions of the plurality of predetermined window resolutions, the steps of providing an input signal, rendering an image of the document, and determining if the on-screen appearance of the computer renderable document meets the predetermined acceptance criteria.

2. The method of claim 1, wherein the input signal is provided by one of a menu selection and a command key sequence.

3. The method of claim 1, wherein the input signal is provided by a command line parameter.

4. The method of claim 1, wherein the input signal is provided via an inter-process procedure call mechanism.

5. The method of claim 4, wherein the inter-process procedure call mechanism is one of dynamic data exchange (DDE), component object model (COM) and remote procedure call (RPC).

6. The method of claim 1, wherein the application is a web browser.

7. The method of claim 1, wherein the computer renderable document contains visual elements that use device dependent positioning algorithms during said rendering.

8. The method of claim 1, wherein the computer renderable document contains visual elements that use device independent positioning algorithms during said rendering.

9. The method of claim 1, wherein the plurality of predetermined window resolutions include 640×480, 800×600, 1024×768, 1280×1024 and 1600×1200 pixels.

10. The method of claim 1, wherein the computer renderable document is defined using a descriptive mark-up language.

11. A computer program product for verifying a computer renderable document for on-screen appearance when displayed by an application adapted to apply any one of a plurality of predetermined window resolutions responsive to an input signal, said computer program product comprising computer executable instructions for performing a method, said method comprising the steps of:
identifying the computer renderable document to be verified for the application;
providing an input signal to the application to select a window resolution of the plurality of predetermined window resolutions;
rendering an image of the document at the selected window resolution on a screen of a reference display monitor of a reference computing platform, wherein the rendered image at the selected window resolution on the screen of the reference display monitor emulates a rendered on-screen appearance of the image at the selected window resolution on a screen of another display monitor of another computing platform, wherein the screen of the another display monitor has a smaller window size than does the screen of the reference display monitor, wherein the reference display monitor comprises a maximum window resolution greater than the selected window resolution, and wherein said rendering is performed by executing the application on the reference computing platform;
determining if the emulated on-screen appearance of the image of the screen of the another display monitor of the another computing platform meets predetermined acceptance criteria at the selected window resolution; and
repeating, for each of the other window resolutions of the plurality of predetermined window resolutions, the steps of providing an input signal, rendering an image of the document, and determining if the on-screen appearance of the computer renderable document meets the predetermined acceptance criteria.

12. The computer program product of claim 11, wherein the input signal is provided by one of a menu selection and a command key sequence.

13. The computer program product of claim 11, wherein the input signal is provided by a command line parameter.

14. The computer program product of claim 11, wherein the input signal is provided via an inter-process procedure call mechanism.

15. The computer program product of claim 14, wherein the inter-process procedure call mechanism is one of dynamic data exchange (DDE), component object model (COM) and remote procedure call (RPC).

16. The computer program product of claim 11, wherein the application is a web browser.

17. The computer program product of claim 1 1, wherein the computer renderable document contains visual elements that use device dependent positioning algorithms during said rendering.

18. The computer program product of claim 11, wherein the computer renderable document contains visual elements that use device independent positioning algorithms during said rendering.

19. The computer program product of claim 11, wherein the plurality of predetermined window resolutions include 640×480, 800×600, 1024×768, 1280×1024 and 1600×1200 pixels.

20. The computer program product of claim 11, wherein the computer renderable document is defined using a descriptive mark-up language.
